(19) United States
(12) Patent Application Publication
(10) Pub. No.: US 2016/0071046 A1
(43) Pub. Date: Mar. 10, 2016

(54) LEARNER ENABLEMENT FORECAST SYSTEM AND METHOD

(71) Applicant: International Business Machines Corporation, Armonk, NY (US)

(72) Inventors: Barbara Reusser, Virginia Beach, VA (US); Debra L. Sheldon, Dunedin, FL (US)

(21) Appl. No.: 14/479,661

(22) Filed: Sep. 8, 2014

(51) Int. Cl. G06Q 10/06

(52) U.S. Cl. CPC G06Q 10/06393

(57) ABSTRACT

A method and computer program product and tool for providing a predictive model that evaluates business needs and requirements against factors of motivation, content relevance and design to provide an indication of a learner's success in applying a training in his/her job situation. The model can generate a value that is compared against a threshold. The threshold is dependent upon the skill type to be applied in executing a job role. Based on the comparison result, the manager or employer makes an informed decision as to the value of the prospective training of the learner. For example, if the value is greater than the threshold, it can be expected that the learner's training will be applied to the job. If the value is lower than the threshold, it can be expected that the learner's training will not be valuable post-training.

### BACKGROUND

1. Technical Field

The present invention relates to the field of evaluating training efficacy for the work place, and more particularly, to a system and method for generating a single forecast success predictor used for forecasting learning and evaluating a likelihood that a trainee will utilize a skill obtained in training to an on-the-job activity.

2. Description of the Related Art

The American Society for Training and Development estimates that, in the US, companies spent $171.5 billion on employee training for 2012. Yet, research suggests that for every training dollar spent, as little as 20 cents of that is actually used in the work place. It had been observed that, generally, trained skills are applied in the work setting at an estimated rate of 10%. More specifically, statistics have been found that have determined that one year after instruction, just 15% of the learners were able to recall and use training. Currently managers, who are responsible for approval of funding for these endeavors do not have any system for forecasting the likelihood that the learner will ever utilize the learned skill in their work setting.

Current methods for evaluation of skills of a trainee, e.g., in a corporate setting, require that the manager develop and understand the details of training and learning which development may require and take years of education and experience in the training and learning environment.

For a manager, becoming this kind of subject matter expert costs thousands of real dollars. It also has opportunity cost because resources devoted to “learning about learning” are taken away from the tasks required to manage people.

### SUMMARY

In order to reduce education waste, before the training even takes place, a system and method provides for the evaluation of learning by providing a way to effectively determine whether a trained skill will translate into on-the-job use.

The system and method combines separate, yet confounding factors into an approach that provides decision support for managers, learners and education designers thus, eliminating waste and eliminating the inefficiencies in the education sector.

According to one aspect, the system and method provides a predictive model that evaluates business needs and requirements against factors of motivation, content relevance and design to provide an indication of a learner's success in applying the training in his/her job situation. The model can generate a value that is compared against a threshold. The threshold is dependent upon the job type. Based on the comparison result, the manager or employer can make an informed decision as to the value of the prospective training of the learner. For example, if the value is greater than the threshold, it can be expected that the learner's training will be applied to the job and hence valuable from a business prospective. If the value is lower than the threshold, it can be expected that the learner's training will not be valuable post-training.

In one aspect, there is provided a method of forecasting skills transfer effectiveness. The method comprises: receiving indicator data relating to a skills transfer metric; assigning a numeric value corresponding to each received indicator data; computing a score based on the assigned numeric values; comparing the score against a predetermined threshold; and sending one or more signals to a user device for indicating a result of the comparing, the user device responsive to the result for recommending an action to admit a learner entry or deny a learner entry to a training program, wherein a programmed hardware processor device performs the receiving, assigning, computing, comparing, and sending result indicating signals.

In a further aspect, there is provided a system of forecasting skills transfer effectiveness. The system comprises: a memory storage device, a hardware processor device coupled to the memory storage device and configured to perform a method to: receive indicator data relating to a skills transfer metric; assign a numeric value corresponding to each received indicator data; compute a score based on the assigned numeric values; compare the score against a predetermined threshold; and send one or more signals to a user device for indicating a result of the comparing, the user device responsive to the result for recommending an action to admit a learner entry or deny a learner entry to a training program.

A computer program product is provided for performing operations. The computer program product includes a storage medium readable by a processing circuit and storing instructions run by the processing circuit for running a method. The storage medium readable by a processing circuit is not only a propagating signal. The method is the same as listed above.

### BRIEF DESCRIPTION OF THE SEVERAL VIEWS OF THE DRAWINGS

FIG. 1 depicts a Learner Enablement Forecasting System (LEFSys) implementing a Return-On-Investment (ROI) Training predictive model that runs on a computer system;

FIG. 2 depicts an example spreadsheet implementation 100 of the predictor model showing receipt and processing of indicators that are associated with a LEFSys model Motivation processing component of FIG. 1 in one embodiment;

FIGS. 3A-3C show an example spread sheet program implementation depicting receipt and processing of indicators that are associated with a LEFSys model Content and Delivery processing component of FIG. 1 in one embodiment;

FIGS. 4A-4B show an example spread sheet program implementation depicting receipt and processing of indicators that are associated with a LEFSys model Post-Training processing component of FIG. 1 in one embodiment;

FIG. 5 shows the LEFSys modeler implementation of a Subject Matter Matrix used to compute an Adjusted Design Average in one embodiment;

FIG. 6 shows the LEFSys modeler implementation of a Motor-Cognitive Environment Matrix used to compute a modified post-training fitness for environment sub-total;

FIG. 7 shows the LEFSys modeler implementation of a Motor-Cognitive Application Matrix used to compute a modified post-training fitness for application sub-total;

FIG. 8 shows a detailed flowchart indicating the LEFSys model process steps according to one embodiment; and

FIG. 9 illustrates one embodiment of an exemplary hardware configuration of a computing system programmed to perform the method steps described herein.

### DETAILED DESCRIPTION OF THE PREFERRED EMBODIMENTS

Detailed embodiments of the invention will be described in conjunction with the accompanying drawings. It should be appreciated that the following description of the detailed embodiments are to explain the execution of an example of the invention, rather to impose any limitation on the scope.

A system and method forecasts whether a specific skill being transferred to a user (e.g., a learner, trainee or employee) during training is likely to be used by the learner or employee during post-training activity. The system is a computer implemented system, referred to herein as a Learning Evaluation Forecasting System (LEFSys), that uses multiple on-the-job performance factors related to employee record and business environment to predict skill application of a trainee or “learner”. Furthermore, since managers normally do not have extensive knowledge of training design and characteristics, LEFSys performs in a decision support role to recommend the best training solution from a business perspective.

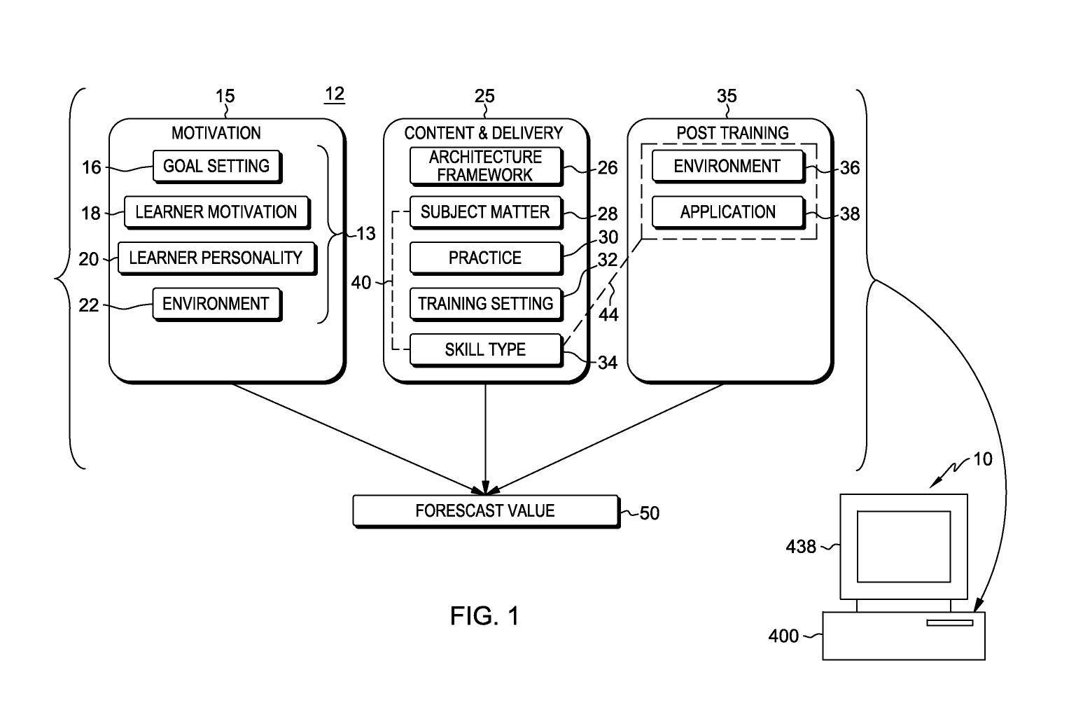

As shown in FIG. 1, the Learner Enablement Forecasting System (LEFSys) 10 includes a Return-On-Investment (ROI) Training predictive model 12 that runs on a computer system 400 and is configured to analyze the likelihood of a return on training investment based on the Motivation (pre-training), Content and Delivery (training) and Post-Training environments. The computer system 400 receives automatically (via the computer system) or by manual input, multiple attribute variables associated with each of the Motivation, Content and Delivery, and Post Training environments. The model 12 is configured for translating the received multiple attribute variables or “indicators” into quantitative (e.g., numeric) values. The Predictor model 12 assesses their collective impact on the skills transfer. The final output, a Forecast Value 50, is an overall score forecasting whether or not the planned learning will transfer into on-the-job use.

In particular, the predictive model 12 runs three main processing components: Motivation 15, Content and Delivery 25, and Post Training 35. Each of these processing components are represented by further processing sub-components 13 of which various input attribute variables or “indicators” are associated. These input attribute variables are assigned quantitative values and uniquely used.

In the embodiment depicted in FIG. 1, the Motivation processing component 15 of model 12 receives attribute variables or indicator inputs for processing by: Goal Setting processing sub-component 16; Learner Motivation processing sub-component18; Learner Personality processing sub-component 20; and Environment processing sub-component 22. Likewise, the Content and Delivery processing component 25 of the LEFSys modeler 12 receives attribute variables or indicator inputs for processing by: Architecture/Framework processing sub-component 26; subject matter processing sub-component28; Practice processing sub-component 30; Training Setting processing sub-component 32; and Skill type processing sub-component 34. Further, the Post Training processing component 35 of the LEFSys model 12 receives attribute variables or indicator inputs for processing by Fitness for Environment processing sub-component 36 and Fitness for Application processing sub-component 38.

In one embodiment, the predictive model 12 inputs and uses up to 41 attribute variables associated with the Motivation, Content and Delivery, and Post Training components. These variables may be automatically input to the system, or input by an individual who has information on the learner, skill, training and work environment. The variables may be a range, e.g., low, medium, high, or may be Boolean in nature (e.g., Yes/No values). The predictive model 12 performs methods to assign or map each of the attribute variables into a corresponding numeric value. In one embodiment, for example, an attribute variable of “low” may translate to a numeric value of 1, an attribute variable of “medium” may translate to a numeric value of 3, and an attribute variable of “high” may translate to a numeric value of 5.

The predictive model 12 performs methods to combine the assigned or mapped numeric values of the attributes values according to a formula. In one embodiment, the formula includes a linear function. Based on the resultant numeric value, the model 12 generates the forecast value 50 indicating whether or not the training will transfer onto the job for that learner and funding sponsor. The forecast value 50 is the ROI (return on investment) predictor that indicates the likelihood of a return on training investment based on the motivation (pre-training), content/delivery (training) and post training environments.

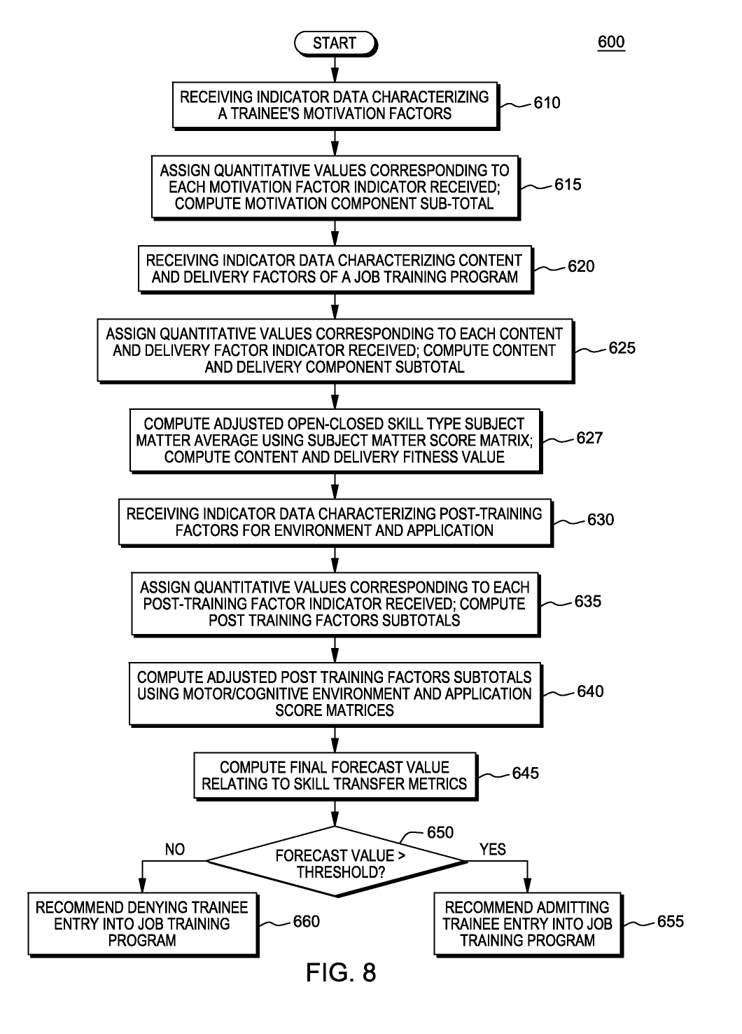

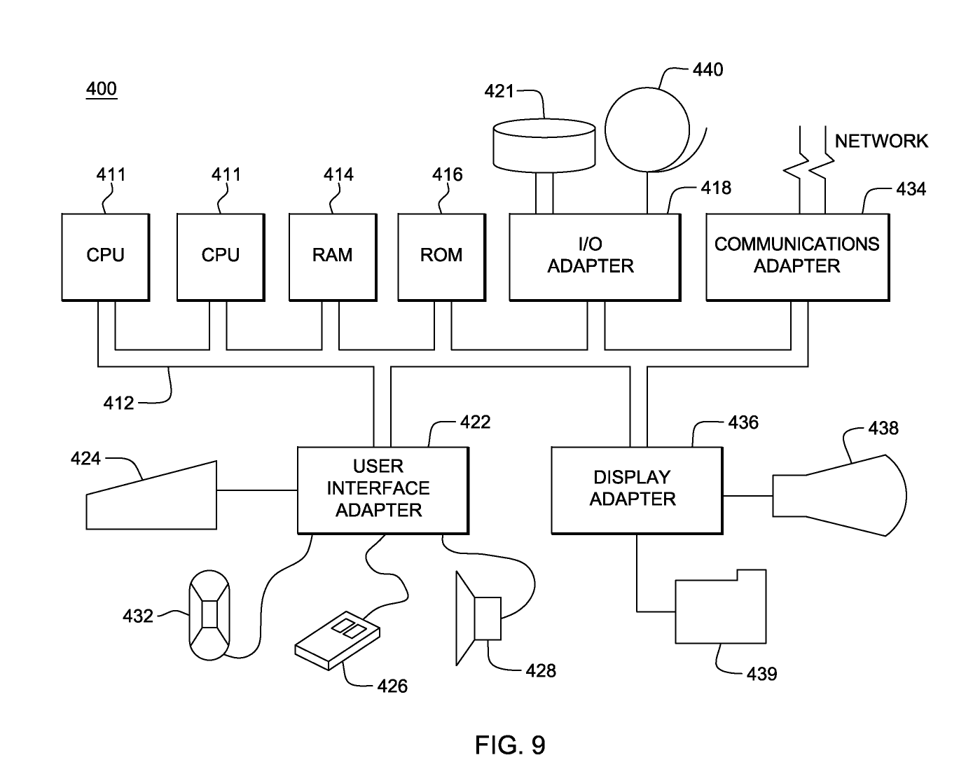

FIG. 8 depicts one implementation of the LEFSys modeling method 600 running in computing system 400. The LEFSys modeler 12 run by a hardware processor in the computing system receives values indicating the various skill transfer metrics and computes a final forecast value. The modeler at 610 first receives data including indicator data characterizing a trainee's motivation factors. The data received by the LEFSys modeler 12 includes indicators or attributes relating to Goal Setting factors, learner motivation factors, learner personality factors, and environment factors. Concurrently or subsequently at 615, the modeler assigns quantitative values corresponding to each trainee motivation factor indicator received and computes a Motivation component sub-total value from the assigned quantitative values. Then, at 620, the LEFSys modeler 12 receives indicator data characterizing content and delivery factors of a job training program. The data received by the LEFSys modeler 12 includes content and delivery indicators or attributes relating to: an architecture/framework, subject matter, practice, training setting, and a skill type. Concurrently or subsequently, at 625, the modeler assigns quantitative values corresponding to each content and delivery factor indicator received and computes a content and delivery sub-total value. Continuing at 627, the modeler computes an adjusted Open-closed skill type subject matter average value based on implementation of a subject matter score mapping matrix. Then, the modeler computes a Content and Delivery Fitness value based on the content and delivery sub-total value and the computed average value.

Continuing, at 630, the LEFSys modeler 12 receives indicator data characterizing post-training factors of the job training program. The data received by the LEFSys modeler 12 includes post-training indicators or attributes characterizing a fitness for Environment and a fitness for application. Concurrently or subsequently, at 635, the modeler assigns quantitative values corresponding to each post-training factor indicator received and computes post training factor sub-totals: an environment sub-total value and an application sub-total value. Then, at 640, there are computed adjusted Post Training (environment and application) factors subtotals using respective Motor/Cognitive environment score mapping matrix and Motor/Cognitive application score mapping matrix, respectively.

Then, at 645 the modeler initiates the hardware processor to compute a forecast value based on the motivation component sub-total, content and delivery fitness and adjusted post training factors values relating to the skill transfer metrics received. At 650, the modeler initiates the hardware processor to compare the forecast value against a predetermined threshold value. If the comparison results in the forecast value being greater than the threshold, then at 655, the hardware processor generates signals for a user device to indicate a recommendation to admit a trainee entry into the job training program. Otherwise, if the comparison results in the forecast value being less than the threshold, then at 660, the hardware processor generates signals for a user device to indicate a recommendation to deny a trainee entry into the job training program.

In one embodiment, LEFSys 10 and predictor model 12 may be implemented as a spreadsheet program (e.g., Excel® Spreadsheet (Trademark of Microsoft Corp.) running on computer system 200 that is programmed to receive the inputs associated with each attribute variable, and generate the forecast value according to formulae. It is understood that other spreadsheet and/or computer program implementations may be used.

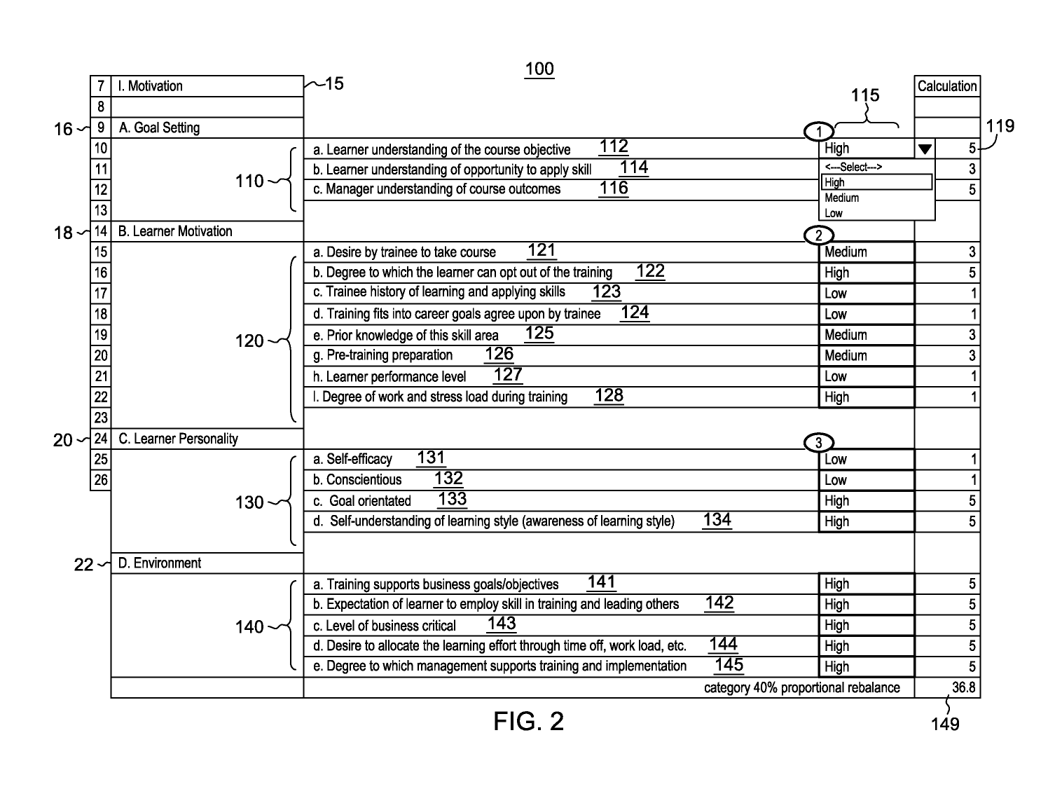

FIG. 2 depicts an example spreadsheet implementation 100 of the predictor model 12 that is associated with a LEFSys model Motivation processing component 15. The model display implementation 100 is provided via a display interface 438 of computer system 400. As shown in FIG. 2, from manual input provided by a user (e.g., a learner or manager) via the displayed spreadsheet interface, or via automated (computer system) signal inputs, the LEFSys model Motivation processing component 15 receives: Goal Setting attribute variables or indicators 110; Learner Motivation indicator inputs 120; Learner Personality indicator inputs 130; and Environment indicator inputs 140. In one embodiment, each of the attribute variables or indicators 110, 120, 130 and 140 are input via an individual drop down selection menu 115 associated with each particular indicator. Generally, the model 12 assigns each entered low, medium or high indicator input a corresponding numeric value, e.g., 1, 3 or 5. This value is depicted in a corresponding spreadsheet value field 119 associated with each corresponding input numeric and each value is stored in a memory of computer system 400 for processing according to an applied function.

With respect to Goal Setting processing sub-component inputs 110: One goal setting input 112 is a value (e.g., low, medium or high) entered into the system 10 via menu 115 for indicating: a) a learner's understanding of the course objective. In one embodiment, LEFSys assigns this low, medium or high input value a corresponding numeric value 1, 3 or 5 and this value is stored in the system as a value in a variable, e.g., A1. A second goal setting input 114 is a value (e.g., low, medium or high) entered into the system via menu 115 that characterizes: b) a learner's understanding of the opportunity to apply the skill. This entered low, medium or high value input is assigned a corresponding numeric value 1, 3 or 5 and is stored by the system as a value in a variable A2. A third goal setting input 116 is a value entered into the system that characterizes: c) a manager's understanding of the course outcomes. This entered low, medium or high value input is assigned a corresponding numeric value 1, 3 or 5 and is stored by the system as a value in a variable A3.

After inputting values for these Goal Setting indicators 16 the modeler further computes and stores in a register or computer memory location an overall Goal setting indicator sub-total value. In one embodiment, this Goal setting indicator sub-total value is computed by a processing device according to:

Goal setting: A1+A2+A3

With respect to Learner Motivation processing sub-component inputs 120. One learner motivation input 121 is a value (e.g., low, medium or high) entered into the system 10 for indicating: a) a trainee's desire to take the course. This entered low, medium or high value input is assigned a corresponding respective numeric value 1, 3 or 5 and is stored by the system as a value in a variable, e.g., B1. A second learner motivation input 122 is a value (e.g., low, medium or high) entered into the system for indicating: b) a degree to which the learner can opt out of the training. This entered low, medium or high value input is assigned a corresponding respective numeric value 1, 3 or 5 and is stored by the system as a value in a variable B2. A third learner motivation input 123 is a value (e.g., low, medium or high) entered into the system for indicating: c) a trainee's history of learning and applying skills. This entered low, medium or high value input is assigned a corresponding respective numeric value 1, 3 or 5 and is stored by the system as a value in a variable B3. A fourth learner motivation input 124 is a value (e.g., low, medium or high) entered into the system for indicating: d) how training fits into career goals agreed upon by trainee. This entered low, medium or high value input is assigned a corresponding respective numeric value 1, 3 or 5 and is stored by the system as a value in a variable B4. A fifth learner motivation input 125 is a value (e.g., low, medium or high) entered into the system for indicating: e) a learner's prior knowledge of this skill area. This entered low, medium or high value input is assigned a corresponding respective numeric value 1, 3 or 5 and is stored by the system as a value in a variable B5. A sixth learner motivation input 16 is a value (e.g., low, medium or high) entered into the system for indicating: g) a learner's pre-training preparation. This entered low, medium or high value input is assigned a corresponding respective numeric value 1, 3 or 5 and is stored by the system as a value B6. A seventh learner motivation input 127 is a value (e.g., low, medium or high) entered into the system for indicating: h) a learner's performance level. This entered low, medium or high value input is assigned a corresponding respective numeric value 1, 3 or 5 and is stored by the system as a value B7. An eight learner motivation input 128 is a value (e.g., low, medium or high) entered into the system for indicating: I) a degree of work and stress load during training. This entered low, medium or high value input is assigned a corresponding respective numeric value 1, 3 or 5 and is stored by the system as a value B8.

After inputting values for these Learner Motivation indicators 120 the modeler 12 further computes and stores in a register or computer memory location an overall Learner Motivation indicator sub-total value. In one embodiment, this Learner Motivation indicator sub-total value is computed by a processing device according to:

Learner Motivation: B1+B2+B3+B4+B5+B6+B7+B8

With respect to Learner Personality processing sub-component inputs 130. One learner personality input 131 is a value (e.g., low, medium or high) entered into the system 10 for indicating: a) a learner's Self-efficacy. This entered low, medium or high value input is assigned a corresponding respective numeric value 1, 3 or 5 and is stored by the system as a value in a variable, e.g., C1. A second learner personality input 132 is a value (e.g., low, medium or high) entered into the system for indicating: b) a learner's conscientiousness. This entered low, medium or high value input is assigned a corresponding respective numeric value 1, 3 or 5 and is stored by the system as a value in a variable C2. A third learner personality input 133 is a value (e.g., low, medium or high) entered into the system for indicating: c) a learner's goal orientation. This entered low, medium or high value input is assigned a corresponding respective numeric value 1, 3 or 5 and is stored by the system as a value in a variable C3. A fourth learner personality input 134 is a value (e.g., low, medium or high) entered into the system for indicating: d) a learner's self-understanding of learning style (i.e., a learner's awareness of learning style). This entered low, medium or high value input is assigned a corresponding respective numeric value 1, 3 or 5 and is stored by the system as a value in a variable C4.

After inputting values for these Learner Personality indicators 130, the modeler 12 further computes and stores in a register or computer memory location an overall Learner Personality indicator sub-total value. In one embodiment, this Learner Personality indicator sub-total value is computed by a processing device according to:

Learner Personality: C1+C2+C3+C4

With respect to Environment sub-component processing inputs 140. One environment input 141 is a value (e.g., low, medium or high) entered into the system 10 for indicating: a) whether the training supports business goals/objectives. This entered low, medium or high value input is assigned a corresponding respective numeric value 1, 3 or 5 and is stored by the system as a value in a variable, e.g., D1. A second environment input 142 is a value (e.g., low, medium or high) entered into the system for indicating: b) a learner's expectation to employ skill in training and leading others. This entered low, medium or high value input is assigned a corresponding respective numeric value 1, 3 or 5 and is stored by the system as a value in a variable D2. A third environment input 143 is a value (e.g., low, medium or high) entered into the system for indicating: c) a level of business critical. This entered low, medium or high value input is assigned a corresponding respective numeric value 1, 3 or 5 and is stored by the system as a value in a variable D3. A fourth environment input 144 is a value (e.g., low, medium or high) entered into the system for indicating: d) a learner's desire to allocate the learning effort through time off, work load, etc. This entered low, medium or high value input is assigned a corresponding respective numeric value 1, 3 or 5 and is stored by the system as a value in a variable D4. A fifth environment input 145 is a value (e.g., low, medium or high) entered into the system for indicating: e) a degree to which management supports training and implementation. This entered low, medium or high value input is assigned a corresponding respective numeric value 1, 3 or 5 and is stored by the system as a value in a variable D5.

After inputting values for these Environment indicators 140, the modeler 12 further computes and stores in a register or computer memory location an overall Environment indicator sub-total value. In one embodiment, a total Learner Personality indicator sub-total value is computed by a processing device according to:

Environment: D1+D2+D3+D4+D5

From each of the sub-totals for the Motivation component 15 indicator values, i.e., the “Goal Setting” indicators sub-total, the “Learner Motivation” indicators sub-total, the “Learner Personality” indicators sub-total, and the “Environment” indicators sub-total, the LEFSys model 12 is configured to compute an overall Motivation component sub-total is computed and stored in computing system 400 according to:

Motivation=[A1: A3+B1:B8+C1:C4+D1:D5]*(weight)

where A1:A3 represents the Goal Setting subtotal A1+A2+A3, B1:B8 represents the Learner Motivation subtotal: B1+B2+B3+B4+B5+B6+B7+B8; C1:C4 represents the Learner Personality subtotal: C1+C2+C3+C4; and D1:D5 represents the Environment subtotal: D1+D2+D3+D4+D5 and the “weight” is a factor reflecting a percent proportional influence of the overall training outcome. In one example, this weight value is 40% or 0.4. But it may range between values 0.37 to 0.43. The Motivation component sub-total value is shown in the display of the spreadsheet implementation of FIG. 2 in a sub-total field 149.

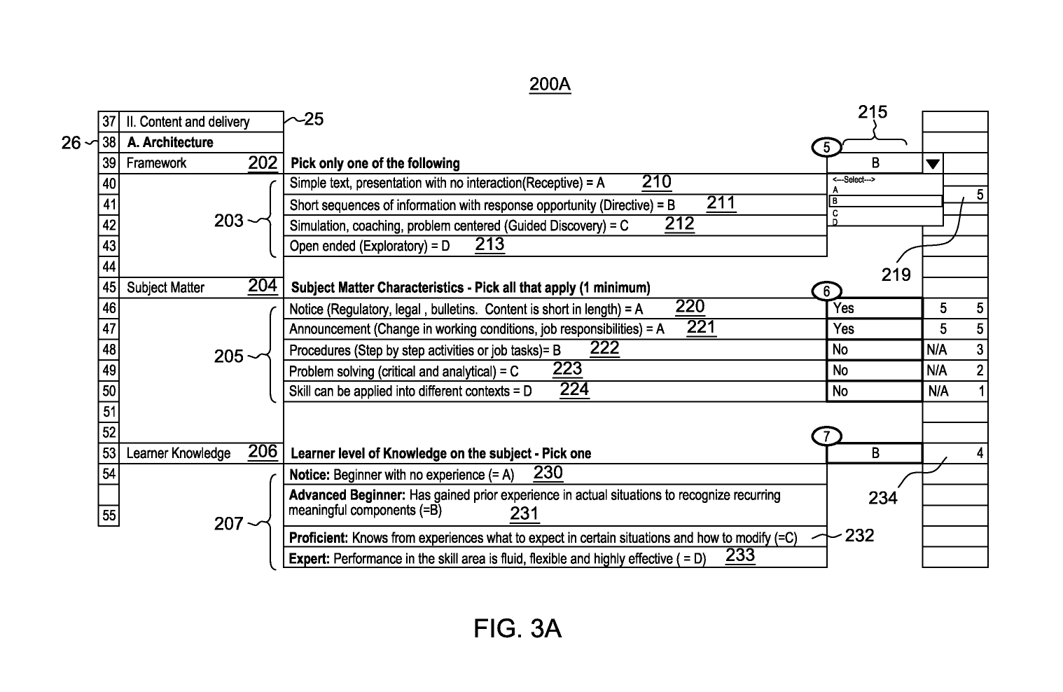

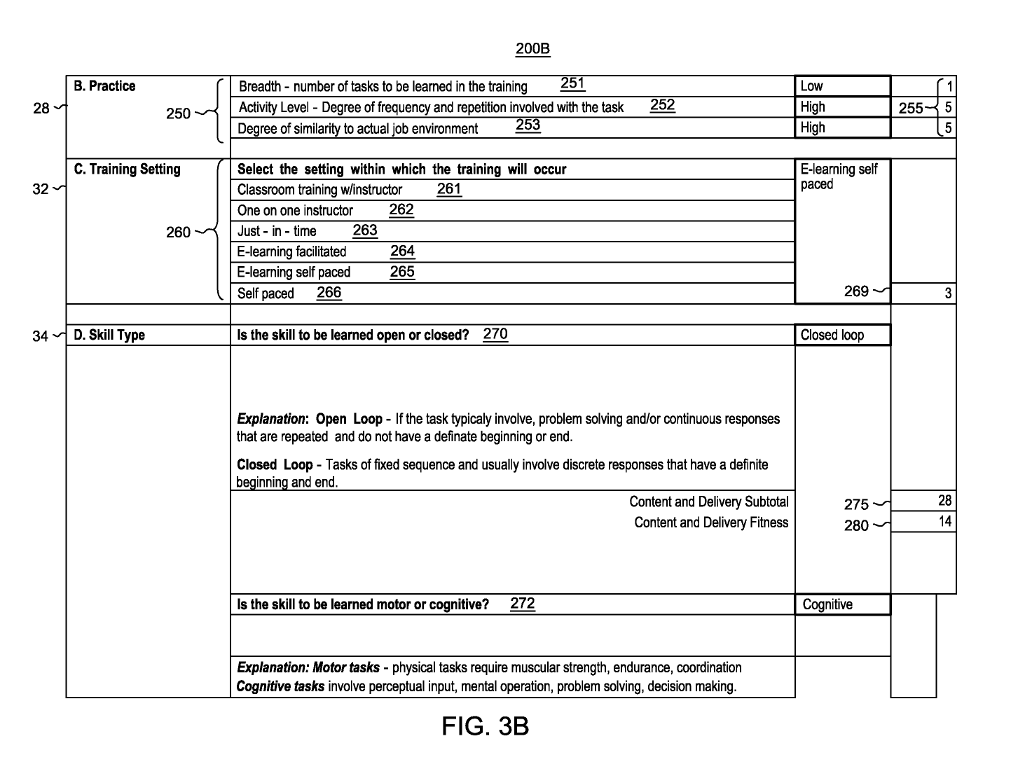

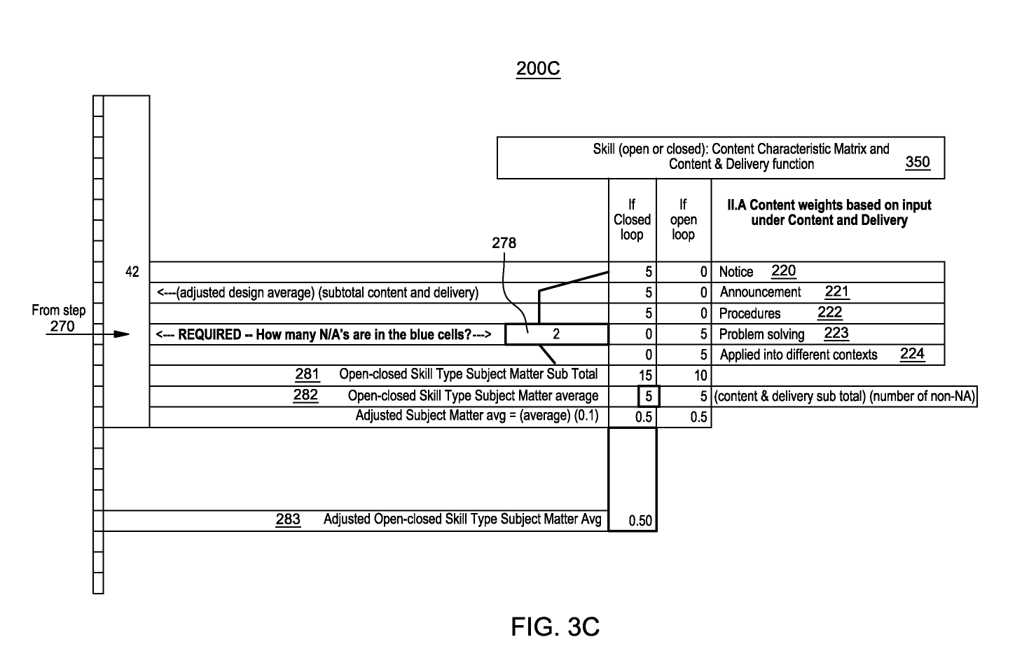

FIGS. 3A-3C depict example spreadsheet implementations 200A, 200B and 200C of the predictor model 12 that is associated with the LEFSys model Content and Delivery processing component 25. The model display implementations are provided via a display interface 438 of computer system 400. The Content and Delivery processing component 25 of the LEFSys modeler 12 is configured to evaluate content and delivery attributes for fitness with the pre-training attributes and the objectives of the training. This fitness is critical to the modeler's predictive capability. To produce this final value, as shown in FIGS. 3A-3B, from manual input provided by a user (e.g., a learner or manager) via the displayed spreadsheet interface, or via automated (computer system) input, the LEFSys model Content and Delivery processing component 25 receives the attribute variables or indicators associated with the Architecture processing sub-component 26, Practice processing sub-component 28, Training Setting processing sub-component 32, and Skill type processing sub-component 34.

In one aspect, the Architecture processing sub-component 26 integrates the “how”, “what” and “who” of the training into the modeler 12. There are attribute variables or indicators input for three Architecture sub-component segments: a Framework segment 202, a Subject Matter segment 204, and a Learner knowledge segment 206.

In one embodiment, as shown in the example spread sheet program implementation of FIG. 3A, the Architecture Framework segment 202 receives a single attribute variable or indicate input that considers the impact of the size of information transferred and the feedback loop of the learner, i.e., the “how” variable of the architecture. The feedback loop is the process whereby learner takes his/her basic understanding of a concept and refines and broadens this understanding through a variety of mechanism such as testing, practice, asking questions, and peer reviews. Each input carries a varying degree of training transfer risk and the user must select one out of four design options 203. LEFSys modeler 12 translates that one user selection into a numeric value. For example, the Framework input is a value (e.g., A, B, C and D) that may be manually input into the system 10 (e.g., by a manager) via a drop down selection menu 215. The selected input value, e.g., A, B, C and D, corresponds to a respective training program design option: a Simple text presentation with no interaction (i.e., Receptive), e.g., option A, 210; a Short sequences of information with response opportunity (i.e., Directive), e.g., option B 211; a Simulation, coaching, problem centered (i.e., Guided Discovery) option C 212; and an Open ended (i.e., Exploratory) option D 213. This entered option value (e.g., Receptive A, Directive B, Guided Discovery C or Exploratory D) input is assigned by LEFSys modeler a corresponding respective numeric value 5, 4, 3 2, and is stored in a memory location in the system as a value in a variable, e.g., E. A corresponding numeric value may be displayed in a field 219 as shown in FIG. 3A.

In one embodiment, the Architecture Subject Matter segment 204 considers characteristics focusing on what is being communicated as it relates to the training method. The content of training carries a varying degree of training transfer risk. More than one characteristic can apply to what is being communicated during the training. Thus, the user may select or input system can designate one or more characteristics 205 of the subject matter.

One Subject Matter attribute variable input 220 is a value (e.g., Yes, No) entered into the system 10 (e.g., by a manager) that corresponds to a “Notice” training content, (e.g., Regulatory, legal, bulletins; or content that is short in length). If a “yes” is selected for the Notice subject matter input, the modeler 12 assigns a quantitative (i.e., numeric) value of 5 that is stored by the system as a value in a variable, e.g., F1. Another Subject Matter input 221 that may be entered into the system 10 is a value (e.g., Yes, No) that corresponds to an “Announcement” training content (e.g., a Change in working conditions, job responsibilities). If a “yes” is selected for the Announcement subject matter input, the modeler 12 assigns a value of 5 that is stored by the system as a value in a variable F2. Another Subject Matter input 222 that may be entered into the system 10 is a value (e.g., Yes, No) that corresponds to a “Procedures” training content (e.g., Step by step activities or job tasks). If a “yes” is selected for the Procedures subject matter input, the modeler 12 assigns a quantitative value of 4 that is stored by the system as a value in a variable F3. Another Subject Matter input 223 that may be entered into the system 10 is a value (e.g., Yes, No) corresponding to a “Problem solving” training content (e.g., critical and analytical). If a “yes” is selected for the Problem solving subject matter input, the modeler 12 assigns a value of 3 that is stored by the system as a value in a variable F4. Another Subject Matter input 224 that may be entered into the system 10 is a value (e.g., Yes, No) that corresponds to “Skill” training content that can be applied into different contexts. If a “yes” is selected that corresponds to “Skill”, the modeler 12 assigns a value of 2 that is stored by the system as a value in a variable, e.g., F5.

After inputting each of the one or more applicable Architecture Subject Matter segment 26 indicator inputs 205, the modeler 12 further computes and stores in a register or computer memory location an overall Subject Matter segment sub-total according to:

Subject Matter: F1+F2+F3+F4+F5

As will be explained in greater detail, in one embodiment, the LEFSys modeler 12 uses the Architecture Subject Matter processing segment to manufacture two variables: the subject matter segment sub-total value, and a weighting for the overall Content and Delivery Open-closed Skill Type Fitness processing sub-component indicator 34. The Subject Matter weighting is represented as impacting an Open-closed Skill Type Fitness sub-total value as depicted by the Skill Type impact line 40 shown in FIG. 1.

Referring back to FIG. 3A, in one embodiment, the Architecture Learner Knowledge segment 206 receives a single attribute variable or indicator input that considers the learner's level of knowledge by bringing in a variable that factors what the learner already knows about the skill. The user (e.g., learner or manager) selects one from of the following four attributes 207: Novice, Advanced Beginner, Proficient, and Expert.

The Novice Learner Knowledge attribute variable input 230 is a value that characterizes the learner as a beginner with no experience. The learner knows general rules to help perform tasks. Knows context-free rules, independent of specific cases, and applied universally. The learner knows simple and inflexible pieces of information. The learner must be told what to do related to the skill. When the Learner Knowledge Novice indicator is selected, the input is a value (e.g., a value “A”) entered via a selection menu into the system 10, and is assigned a quantitative value, e.g., 5.

The Advanced Beginner attribute variable input 231 characterizes the learner as demonstrating acceptable performance of the skill. The learner has gained prior experience in actual situations to recognize recurring meaningful components and knows the principles and based on experiences can begin to be formulated to guide actions. When the Learner Knowledge Advanced Beginner indicator is selected, the input is a value in a variable (e.g., “B”) entered via a selection menu into the system 10, and is assigned by the LEFSys model a quantitative value of 4.

The Proficient attribute variable input 232 characterizes the learner as perceiving and understanding situations employing the skill as whole parts. The learner has a more holistic understanding which improves decision-making and learns from experiences what to expect in certain situations and how to modify plans. The learner is more aware of long-term goals and gains perspective from planning own actions based on conscious, abstract, and analytical thinking. When the Proficient Learner Knowledge indicator is selected, the input is a value (e.g., a value “C”) entered via a selection menu into the system 10, and is assigned a quantitative value of 3.

The Expert attribute variable input 233 characterizes the learner as no longer relying on principles, rules, or guidelines to connect situations and determine actions. The learner has much more background of experience and has an intuitive grasp of clinical situations. The learner's performance is fluid, flexible, and highly proficient. When the Expert Learner Knowledge indicator is selected, the input is a value (e.g., a value “D”) entered via a selection menu into the system 10, and is assigned a quantitative value of 2.

From the single entered Learner Knowledge value (e.g., Novice A, Advanced Beginner B, Proficient C or Expert D) input, the LEFSys modeler assigns a corresponding respective numeric value 5, 4, 3 2, that is stored by the system as a value in a variable, e.g., G. The corresponding numeric value may be displayed in a field 234 as shown in FIG. 3A.

In one aspect, the Practice processing sub-component 28 considers the number of new skills or tasks the training covers, as well as how often these are reinforced during the course of the training. It also considers how realistic the training is. These attributes, and the degree to which they apply, are positively correlated to skill retention and usage after training. Users (or automated) input the degree to which each of these attributes are true and the LEFSys modeler 12 translates these inputs into numeric values for use in the forecasting formula.

In one embodiment, as shown in the example spread sheet program implementation 200B of FIG. 3B, the Practice processing sub-component 28 receives attribute variables 250 from a user, e.g., a manager, or system.

One Practice processing sub-component input 251 is a value or (e.g., low, medium or high) entered into the system 10 via a drop down selection menu (not shown), for indicating: a) a “Breadth” of training, e.g., representing a number of tasks to be learned in the training. This entered low, medium or high value input is assigned a corresponding numeric value 1, 3 or 5 respectively and is stored in a memory by the system as a value in a variable, e.g., H1. A second Practice indicator input 252 is a value (e.g., low, medium or high) entered into the system 10 for indicating: b) an Activity Level representing a degree of frequency and repetition involved with the task. This entered low, medium or high value input is assigned a corresponding numeric value 1, 3 or 5 respectively and is stored by the system as a value in a variable, e.g., H2. A further Practice indicator input 253 is a value (e.g., low, medium or high) entered into the system 10 that characterizes: c) a degree of similarity to actual job environment. This entered low, medium or high value input is assigned a corresponding numeric value 1, 3 or 5 respectively and is stored by the system as a value in a variable, e.g., H3. Numeric values assigned as H1-H3 are shown in corresponding display fields 255.

After receiving (via a manual or automated fashion) input values for the Practice processing sub-component indicators 250, the LEFSys modeler 12 further computes and stores in a register or computer memory location an overall Practice indicator sub-total value. In one embodiment, this Practice indicator sub-total value is computed by a processing device according to:

Practice: H1+H2+H3

In one embodiment, as shown in the example spread sheet program implementation 200B of FIG. 3B, the Training Setting processing sub-component 32 receives from a user, e.g., a manager, or automated means, one of six attribute variables 260 that influences the actual training outcome. Via manual (or automated) inputs, one of the six possible settings 260 is selected via a drop down menu (not shown) and the LEFSys modeler 12 translates this input into a numeric value for use in the forecasting formula.

One selectable input 261 characterizing the Training Setting is a.) Classroom training with an instructor. If this attribute is selected, the modeler assigns this input into a quantitative value, e.g., 5. Another selectable input 262 characterizing the Training Setting is b.) whether there is a one-on-one with instructor training. If this setting is selected, the modeler assigns this input into a numeric value of 5. Another selectable input 263 characterizing the Training Setting is c.) a Just-in-time training. If this setting is selected, the modeler assigns this input into a numeric value of 4. Another selectable input 264 characterizing the Training Setting is d.) if the training is E-learning facilitated. If this setting is selected, the modeler assigns this input into a numeric value of 4. Another selectable input 265 characterizing the Training Setting is e.) if the E-learning self paced. If this setting is selected, the modeler assigns this input into a numeric value of 3. A final selectable input 266 characterizing the Training Setting is f.) whether the training is Self paced. If this setting is selected, the modeler assigns this input into a numeric value of 2.

After inputting a single Training Setting indicator, the LEFSys modeler 12 further computes and stores in a register or computer memory location an overall Training Setting processing sub-component sub-total, e.g., a value in a variable (I). In one embodiment, this Training Setting indicator sub-total value (I) is computed by a processing device. The corresponding numeric value may be displayed in a field 269 as shown in FIG. 3A.

With the above quantitative values entered into the system, LEFSys modeler 12 creates a Subtotal value for the Content and Delivery component 25 according to a formula:

Subtotal Content and Delivery=(Framework))+(SubjectMatter)+(LearnerKnowlege)+(Practice)+(TrainingSetting)

The Content and Delivery component sub-total value is shown in the display of the spreadsheet implementation of FIG. 3B in a sub-total field 275.

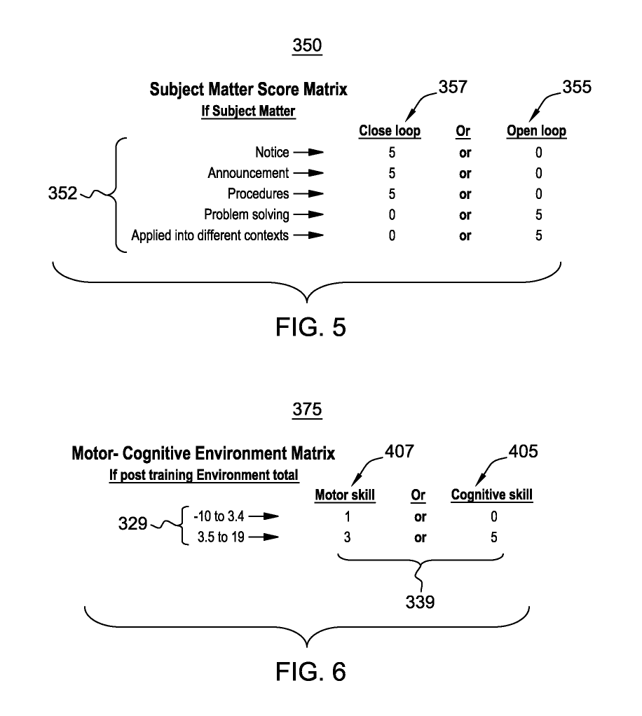

In one embodiment, as shown in the example spread sheet program implementation 200B of FIG. 3B, the Skill Type processing sub-component 34 receives a further input attribute 270 characterizing the skill type or nature of the skill. In one embodiment, the skill type attribute 270 is one of: Open or Closed. As described herein, the skill type (open or closed) drives an adjusted design average as described herein with respect to FIG. 3C. In one embodiment, a Closed-loop skill type is where the work environment is predictable—the skill is performed in an unchanging environment. The action, physical or mental is the goal of the skill. An Open-loop skill type is where the work environment is variable and unpredictable during action. The task typically involves problem solving and/or continuous responses that are repeated and do not have a definite beginning or end. Via manual or automated technology, the skill type attribute 270 is entered into the system 10. With the Skill type variable for Open-closed and Subject Matter (Fn)) selections known, the LEFSys modeler 12 creates an Adjusted Design Average (i.e., the final output of architecture, practice and training setting as determined by the skill type to be learned) using a Subject Matter Matrix such as shown in FIG. 5. In FIG. 5, a subject matter score matrix 350 maps each selected subject matter attribute(s) 352 that were selected with a corresponding value 355 or 357 depending upon the applicable Open-loop or Closed-loop nature of the selected skill type attribute 270. That is, for each Subject Matter attribute selected from attributes 205 in FIG. 3A, and as determined by the Open-closed loop nature of the skill, LEFsys system 12 assigns the corresponding qualitative value found in the Subject Matter Matrix 300. For example, if the first three (3) Subject Matter attributes 220, 221 and 222 were selected and the Subject Matter is Closed loop type or Open loop the Notice qualitative value is 5 or 0, the Announcement qualitative value is 5 or 0, and the Procedures qualitative value is 5 or 0, etc. If the other subject matter attributes 223, 224 were selected and the Subject matter is Closed-loop type or Open-loop type, the Problem solving qualitative value is 0 or 5 and the Applied into different contexts qualitative value 0 or 5. In one embodiment, the system uses a prompted entry of a value to identify the correct divisor by indicating the amount of Subject Matter attributes not selected, i.e., not applicable (N/A) as indicated as an entry in field 278. From this Subject Matter Matrix mapping, an Open Skill type or a Closed Skill Type Subject matter qualitative sub-total value 281 is computed from the matrix.

In one example, given a Closed-loop skill type selection each selected Subject Matter attributes 220, 221 and 222 map to a value of 5, generating an Open-closed Skill Type Subject matter qualitative sub-total value 281 of 15, for example. Alternatively, in another example, given an Open-loop skill type selection each selected Subject Matter attribute 220, 221 and 222 map to a value of 0, generating a Open-closed Skill Type Subject matter subtotal 281 of 10, for example.

An Open-closed Skill Type Subject matter average 282 is then calculated as a value in a variable (J) according to:

Open-closed Skill Type Subject Matter Average: J=t/n

where n=the number of Subject Matter attributes selected, or alternatively, the number of non-N/A in Field and t=Open-closed Skill Type Subject matter qualitative sub-total value 281.

Thus, as depicted in the example presented spreadsheet portion in FIG. 3C, the modeler further computes and stores in a register or computer memory location an Open-closed Skill Type Subject Matter Average value 282 (J)=15/3=5.

In a further embodiment, the LEFSys modeler 12 weighs the Subject Matter Average 282 (J) by a factor reflecting a percent proportional influence of the overall training outcome. Thus the Open-closed Skill Type Subject Matter Average 282 is adjusted to generate an Adjusted Open-closed Skill Type Subject matter average value 283 as follows:

Adjusted Open-closed Skill Type Subject Matter Average=J*(weight)

In one embodiment, this weight value is 10% or 0.1. But it may be another value within a range between values 0.05 to 0.15. Thus, in the embodiment depicted, the Adjusted Open-closed Skill Type Subject Matter Average=J*(0.1)=5*(0.1)=0.5.

After mapping using the subject matter score matrix 350 of FIG. 5, using calculations performed by a processor and presented via the spreadsheet program portion of FIG. 3C, a processing device functioning to perform the modeler 12 computes an Adjusted Design Average sub-total value for the Content and Delivery component in a variable (K). The Adjusted Design Average sub-total value is shown in the display of the spreadsheet implementation of FIG. 3B in a sub-total field 280. That is, the final step in arriving at the Content and Delivery Fitness value 280 is a weighting of the Content and Delivery Subtotals performed by the LEFSys modeler 12 as follows:

Content and Delivery Fitness: K=[(E)+(F1: F5)+G+(H1: H3)+I](J*(weight))

where E represents the Architecture Framework subtotal, F1:F5 represents the Subject Matter subtotal: F1+F2+F3+F4+F5; G represents the Learner Knowledge subtotal; H1:H3 represents the Practice subtotal: H1+H2+H3; I represents the Training Setting subtotal; and J*(weight) represents the Adjusted Open-closed Skill Type Subject Matter Average. The value displayed in field 280 is alternately computed as a product of the Content and Delivery component sub-total value 275 and the Adjusted Open-closed Skill Type Subject Matter Average 283 computed by processing depicted in FIG. 3C.

In a further embodiment, as shown in the example spread sheet program implementation 200B of FIG. 3B, the Skill Type processing sub-component 34 receives a further input attribute 272 characterizing the nature of the skill as being motor or cognitive. Motor tasks include physical tasks (acts of physically performing an action), e.g., that require muscular strength, endurance, coordination. Cognitive (skill) tasks include tasks that involve, e.g., perceptual input, mental operation, problem solving, and decision making. Thus, there is entered into the system 10 a selection 272 of whether the training is for a motor or a cognitive skill. As will be explained in greater detail herein below, the selection of a motor or a cognitive Skill Type impacts a fitness score for the Post-Training component Fitness for Environment and Fitness for Application attributes, 36, 38 as depicted by the Skill Type impact line 44 in FIG. 1.

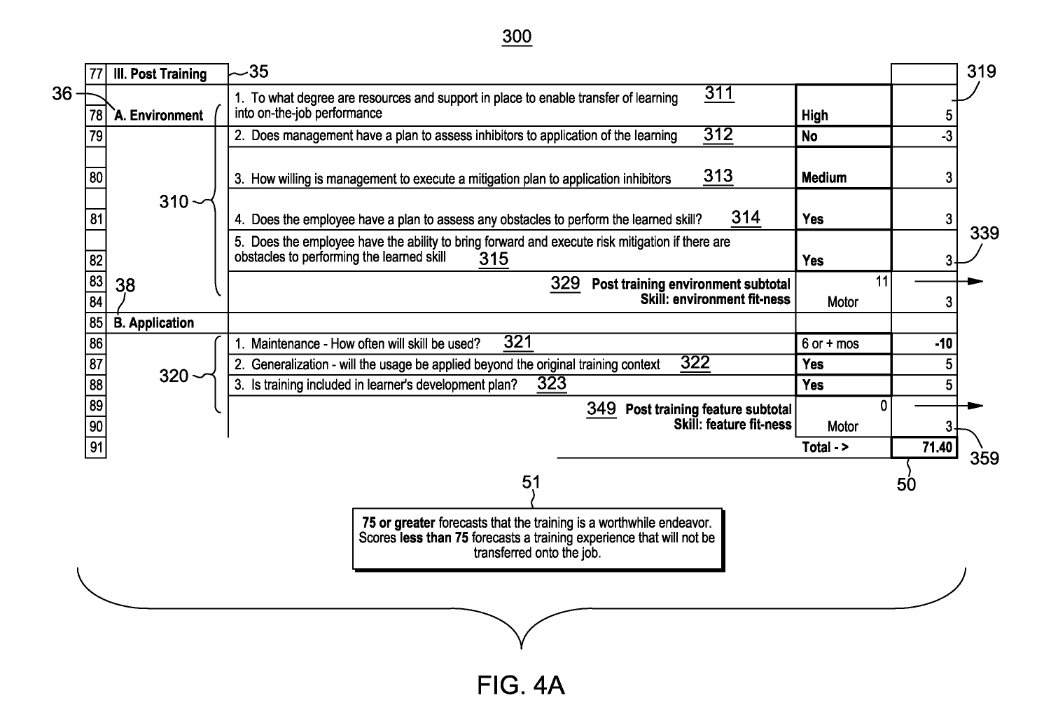

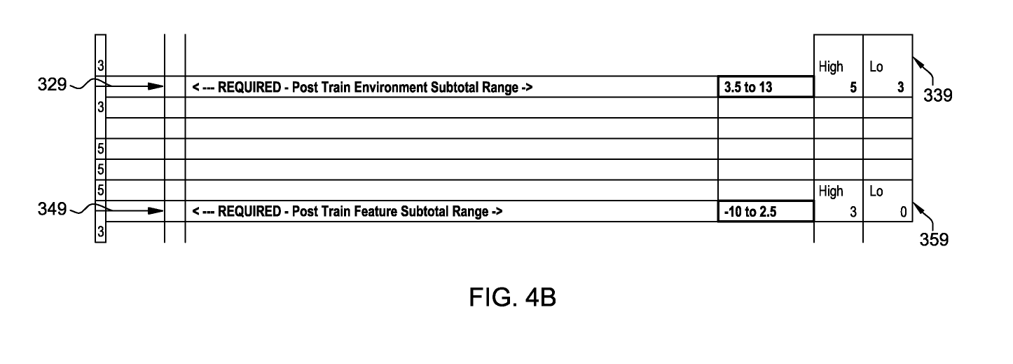

FIG. 4A depicts an example spreadsheet implementation 300 of the predictor model 12 that is associated with the LEFSys model Post Training processing component 35 that evaluates what happens after training occurs in forecasting the actual outcome. The model display implementation 300 is provided via a display interface 438 of computer system 400. As shown in FIG. 4A, from manual input provided by a user (e.g., a learner or manager) via the displayed spreadsheet interface, or via automated (computer system) input, the LEFSys model Post Training processing component 15 receives two indicators: a Fitness for Environment 36 and a Fitness for Application 38. Both of these indicators incorporate motor or cognitive skill considerations into determining fitness of the training, given the environment and the application. The Fitness for Environment 36 receive variables or indicators 310 and the Fitness for Application 38 receive indicator inputs 320. In one embodiment, each of the attribute variables or indicators 310, 320 are input via an individual drop down selection menus associated with each particular indicator. Generally, the model 12 assigns each entered low, medium or high indicator input a corresponding numeric value, e.g., 1, 3 or 5. Additionally, the model 12 may assign each entered Yes or No indicator input a corresponding numeric value, e.g., 3 or 0. In one instance, an entered No indicator input may assigned a numeric value of −3. These values are depicted in a corresponding spreadsheet value field 319 associated with each corresponding input numeric and each value is stored in a memory of computer system 400 for processing according to an applied function.

In one embodiment, as will be described in greater detail herein, the Fitness for Environment indicator inputs 310 is a function of a Fitness for Motor-Cognitive Environment Matrix 375 such as shown in FIG. 6. First, a user (or automated technology) inputs the following values for attributes which the LEFSys modeler 12 converts into a numeric equivalent and then totals.

Referring back to FIG. 4A, a first Fitness for Environment attribute input 311 includes a value (e.g., none, low, medium or high) entered into the system 10 that characterizes a degree to which resources and support are in place to enable transfer of learning into on-the-job performance. This entered low, medium or high value input is assigned a corresponding quantitative value 1, 3 or 5 respectively and is stored by the system as a value in a variable L1. In one embodiment, the “none” value input is assigned a corresponding quantitative value of −10.

A second Fitness for Environment attribute input 312 is a value (e.g., Yes, No) entered into the system 10 that indicates whether there is a management plan to assess inhibitors to application of the learning. If a “yes” is selected for this Fitness for Environment attribute, the modeler 12 assigns a corresponding number value, e.g., +3 and is stored by the system as a value in a variable L2. If a “no” is selected for this Fitness for Environment attribute, the modeler 12 assigns a corresponding number value of, e.g., −3, and is stored by the system as a value in a variable L2.

A third Fitness for Environment attribute input 313 is a value (e.g., low, medium or high) entered into the system 10 that indicates a willingness of management to execute a mitigation plan to application inhibitors. This entered low, medium or high value input is assigned a corresponding quantitative value 1, 3 or 5 respectively and is stored by the system as a value in a variable L3.

A fourth Fitness for Environment attribute input 314 is a value (e.g., Yes, No) entered into the system 10 that indicates whether the trainee has a plan to assess any obstacles to perform the learned skill. If a “yes” is selected for this Fitness for Environment attribute, the modeler 12 assigns a corresponding quantitative value, e.g., +3 and is stored by the system as a value L4. If a “no” is selected for this Fitness for Environment attribute, the modeler 12 assigns a corresponding number value of, e.g., 0, and is stored by the system as a value in a variable L4.

A fifth Fitness for Environment attribute input is a value (e.g., Yes, No) entered into the system 10 that indicates whether the trainee has the ability to bring forward and execute risk mitigation if there are obstacles to performing the learned skill. If a “yes” is selected for this Fitness for Environment attribute, the modeler 12 assigns a corresponding number value, e.g., +3 and is stored by the system as a value L5. If a “no” is selected for this Fitness for Environment attribute, the modeler 12 assigns a corresponding quantitative value of, e.g., 0, and is stored by the system as a value in a variable L5.

After receiving (via a manual or automated fashion) input values for the Fitness for Environment processing sub-component indicators 310, the LEFSys modeler 12 further computes and stores in a register or computer memory location an overall Fitness for Environment indicator sub-total value 329. In one embodiment, this Post Training Fitness for Environment indicator sub-total value 329 is computed by a processing device according to:

Post Training Environment Subtotal: L1+L2+L3+L4+L5

In one embodiment, from the prior input indicator 272 of FIG. 3B indicating whether the training is for a motor or a cognitive skill, the LEFSys modeler 12 creates an environment fitness score 339 using a Motor-Cognitive Environment Matrix 375 such as shown in FIG. 6. In FIG. 6, the Motor-Cognitive Environment Matrix 375 maps the Post Training Environment Subtotal value 329 into the fitness score 339 depending upon the applicable skill being a cognitive skill type 405 or a motor skill type 407. The LEFSys modeler determines the Fitness for Environment score 339 by referencing the corresponding value in the Fitness for Motor-Cognitive Environment Matrix 375. For example, if the Post Training Fitness for Environment indicator sub-total value 329 is a value between −10 to 3.4, then the mapped environment fitness score value is 1 or 0 depending if the skill type is motor 407 or cognitive 405 respectively. Otherwise, if the Post Training Fitness for Environment indicator sub-total value 329 is a value between 3.5 to 19, then the mapped environment fitness score value is 3 or 5 depending if the skill type is motor 407 or cognitive 405, respectively. As shown in the example LEFSys spreadsheet implementation portion of FIG. 4B, a Post Training Environment Subtotal value 329 of 11 maps into a fitness score 339 of a high value 5 or a low value 3. The LEFSys modeler 12 then stores this environment fitness value 339 as a value in a variable, e.g., M.

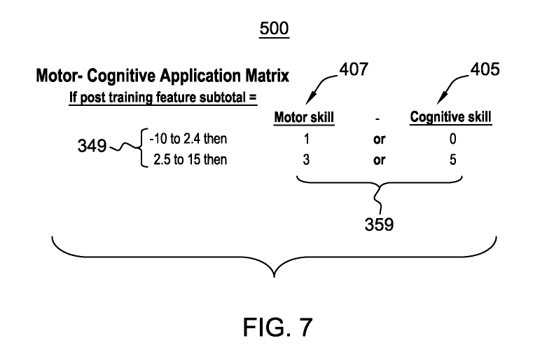

Referring back to the LEFSys modeler implementation depicted via an example display spreadsheet interface 300 of FIG. 4A, the computer system 375 further receives a Fitness for Application 38 indicator variables 320. The Fitness for Application indicator inputs 38 consider how often and how wide-ranging the application of the skill under training is expected to be once training is complete. This indicator also incorporates motor or cognitive skill considerations into determining fitness of the training, given the application. Thus, in one embodiment, as will be described in greater detail herein, the Fitness for Application indicator inputs 320 are a function of a Fitness for Motor-Cognitive Environment Matrix 500 such as shown in FIG. 7. First, a user (or automated technology) inputs the following values for attributes which the LEFSys modeler 12 converts into a numeric equivalent and then totals.

Referring back to FIG. 4A, a first Fitness for Environment attribute input 311 includes a value (e.g., none, low, medium or high) entered into the system 10 that characterizes a degree to which resources and support are in place to enable transfer of learning into on-the-job performance. This entered low, medium or high value input is assigned a corresponding quantitative value 1, 3 or 5 respectively and is stored by the system as a value in a variable L1. In one embodiment, the “none” value input is assigned a corresponding quantitative value of −10.

Referring back to FIG. 4A, a first Fitness for Application attribute input 321 is a value (e.g., daily, weekly or monthly or greater than 6 months) selected for entry into the system 10 that indicates: a Maintenance, i.e., a frequency of which skill will be used. If “daily” is selected, LEFSys modeler 12 assigns a corresponding number value of 5, for example, and is stored by the system as a value in a variable N1. If “Weekly/Monthly” is selected, LEFSys modeler assigns a corresponding number value of 3, for example, and is stored by the system as a value in a variable N1. If “>6 months” is selected, LEFSys modeler assigns a corresponding number value of (−10), for example, and is stored by the system as a value in a variable, e.g., N1.

A second Fitness for Application attribute input 322 is a value (e.g., Yes, No) entered into the system 10 that indicates: a Generalization, i.e., whether skill usage be applied beyond the original training context. If a “yes” is selected for this Fitness for Application attribute, the modeler 12 assigns a corresponding number value, e.g., +5 and is stored by the system as a value in a variable N2. If a “no” is selected for this Fitness for Environment attribute, the modeler 12 assigns a corresponding number value of, e.g., 0, and is stored by the system as a value in a variable N2.

A third Fitness for Application attribute input 323 is a value (e.g., Yes, No) entered into the system 10 that indicates: whether the training is included in the learner's development plan. If a “yes” is selected for this Fitness for Application attribute, the modeler 12 assigns a corresponding number value, e.g., +5 and is stored by the system as a value in a variable N3. If a “no” is selected for this Fitness for Environment attribute, the modeler 12 assigns a corresponding number value of, e.g., 0, and is stored by the system as a value in a variable N3.

After receiving (via a manual or automated fashion) input values for the Fitness for Application processing sub-component indicators 320, the LEFSys modeler 12 further computes and stores in a register or computer memory location an overall Fitness for Application indicator sub-total value 349. In one embodiment, this Post Training Fitness for Application indicator sub-total value 349 is computed by a processing device according to:

Application Subtotal: N1+N2+N3

In one embodiment, from the prior input indicator 272 of FIG. 3B indicating whether the training is for a motor or a cognitive skill, the LEFSys modeler 12 creates an application fitness score 359 using a Motor-Cognitive Application Matrix 500 such as shown in FIG. 7. In FIG. 7, the Motor-Cognitive Application Matrix 375 maps the Post Training Environment Subtotal value 349 into the fitness score 359 depending upon the applicable skill being a cognitive skill type 405 or a motor skill type 407. The LEFSys modeler determines the Fitness for Application score 359 by referencing the corresponding value in the Fitness for Motor-Cognitive Application Matrix 500. For example, if the Post Training Fitness for Application indicator sub-total value 349 is a value between −10 to 2.4, then the mapped application fitness score value is 1 or 0 depending if the skill type is motor 407 or cognitive 405 respectively. Otherwise, if the Post Training Fitness for Application indicator sub-total value 349 is a value between 2.5 to 15, then the mapped environment fitness score value is 3 or 5 depending if the skill type is motor 407 or cognitive 405, respectively. As shown in the example LEFSys spreadsheet implementation portion of FIG. 4B, a Post Training Application Subtotal value 349 of 0 maps into a fitness score 339 of a high value 3 or a low value 0. The LEFSys modeler 12 then stores this environment fitness value 339 as a value in a variable, e.g., 0.

Recognizing that the above components have a collective impact on skills transfer, the above inputs are used to generate a final Forecast Value 50 using the following formula:

Forecast Value=(Motivation)+(Content and Delivery Fitness)+(Post Training)

where Motivation=[A1::A,3+B1::B8+C1:C4+D1:D5] *(0.40); Content and Delivery=[(E1:E4)+(F1:F5)+G+(H1:H3)+I](J*weight) and Post Training=M+O.

Finally, LEFSys modeler 12 uses the Forecast Value 50 to convert the quantitative information back into actionable output, e.g., recommending to admit or deny a learner entry into a training program, which recommendation may be communicated to a manager or like decision maker.

In one embodiment, the LEFSys modeler 12 compares the computed forecast value 50 against a threshold value, e.g., 75, where a forecast value of 75 or greater indicates that the training is a worthwhile endeavor. Forecast value scores less than 75 forecasts that the planned learning will not transfer into on-the-job use. In one embodiment, the threshold value is dependent upon the skill type to be applied in executing a job role.

Then, a hardware processor device of the computer system makes the forecast data and/or recommendation 51 immediately available to a user device, e.g., a display, such as by generating signals for receipt by a user display device for access by a user, e.g., a manager. For example, the forecast value 50 is generated in the spreadsheet implementation portion 300 on a user display device 438 shown in FIG. 1. Alternatively, the computer device 400 may automatically generate signals in the form of an e-mail message which may be communicated to a remote user via a network.

Thus, based on a result of said comparing, a user, such as a manager, may respond to the value for recommending an action to admit a learner entry or deny a learner entry to a training program.

Thus, LEFSys modeler 12 bridges the gap of managers' lack of expertise in training design.

The Advantages of the LEFSys 10 over a manager developing a detailed understanding of training and learning are multi-fold: The LEFSys 10 returns results quicker in that once variables are input, the results are immediate. Enabling the decision support aspects of LEFsys involve newer technologies (e.g., cloud and open technology) that allow greater access to information and advanced analytics. The LEFSys 10 uses collaborative and shared services technologies to remove traditional boundaries managers face in responding to learning requests as well as supporting a continuum of education.

One example application of the LEFSys modeler 12 implemented in computer system 400 is a scenario relating to training on an automatic external defibrillator for a customer software call center support technician. In this scenario, a customer support technician is asked to take training on an automated external defibrillator. The technician and manager fully understand that the course will be on operating a specific model defibrillator. The technician has read up on the device. The technician's long term professional objectives are documented and include the role as safety lead. Given these motivation factors, this motivation processing component will be positively correlated. With respect to Content and Delivery: it has been selected that the given training is coaching and simulation. The act of operating the mechanism is procedure based and the learner has no experience on the subject. Operating the mechanism is a three-step operation and is motor skills based. With respect to the Post Training Environment: The employee works at night and there is one other person in the building at that time. Management has agreed to move the technician in to a day time slot a time with 100 other people are in the building. It is likely the skill will never be used. In this first example scenario, the LEFSys model result may be a forecast value of: 86. This training, though likely never to be used, will result in skills transfer when needed, due to motivation of learner, manager and skills type.

A second example application of the LEFSys modeler 12 implemented in computer system 400 is a scenario relating to training on a process improvement, black belt, Lean Six Sigma methodology for a business analyst. In this scenario, with respect to motivation: a poorly rated transactional business analyst is being asked by management to take the training because funding is available for it this year. The manager has no plans to rearrange the learners schedule and is unsure of using this methodology in the day to day operation in the department. With respect to content and delivery: the training is self paced and uses manufacturing process as examples. The methodology involves 13 tools and these tools are simulated once, each, during the training. The learner has never heard of Lean Six Sigma before and as such has no experience using these tools. The skills involve, cognitive, open loop skills. With respect to Post Training: there is no plans for the learner to apply these skills to a current job role. The training used manufacturing environment examples of a complex process where the learner works in a transactional setting it will be difficult to apply to another context. In this second example scenario, the LEFSys model result may be a forecast value of: 8.93. This training, covers a complex process using material not fitted to the scenario within which is likely to be used by an unmotivated learner, it will not result in skills transfer.

A third example application of the LEFSys modeler 12 implemented in computer system 400 is a scenario relating to a learner must take training on fraud prevention. With respect to motivation: the learner is low motivated, and cannot opt out of the training. The company fully supports this training and has integrated this message into all aspects of their internal business. The learner does not believe they can impact outcome and is not goal oriented. With respect to Content and Delivery: the training covers the regulatory nature of the law and is a skill that can be applied to different context. The learner has been trained on this topic annually. The opportunity to commit fraud occurs daily. Fraud prevention is an open loop, cognitive task. With respect to Post Training: the opportunity to use this skill exists, daily. The skill can be applied to various scenarios and is part of the learner's performance plan. In this third example scenario, the LEFSys model result may be a forecast value of: 70.2. This training involves a low motivated, ineffective learner. Even though the cognitive skill could be applied daily in this environment, the learner likely will not transfer this knowledge on to the job. Since the training is not justified, the manager should be aware that the learner will need additional coaching for this needed skill.

Referring to FIG. 8 illustrates one embodiment of an exemplary hardware configuration of a computing system 400 programmed to perform the method steps described herein with respect to FIG. 8. The hardware configuration preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of forecasting skills transfer effectiveness comprising:
receiving indicator data relating to a skills transfer metric;
assigning a numeric value corresponding to each received indicator data;
computing a score based on said assigned numeric values;
comparing said score against a predetermined threshold; and
sending one or more signals to a user device for indicating a result of said comparing, said user device responsive to said result for recommending an action to admit a learner entry or deny a learner entry to a training program,
wherein a programmed hardware processor device performs said receiving, assigning, computing, comparing, and sending result indicating signals.

2. The method of claim 1 wherein said one or more signals indicate recommending an action to admit if said comparing results in said score being greater than said predetermined threshold.

3. The method of claim 1, wherein said received indicator data relates to characterizing trainee motivation factors, said trainee motivation factors comprising one or more of:
a goal setting factor,
a learner motivation factor,
a learner personality factor, and
an environment factor, said method further comprising:
assigning values associated with each said goal setting, learner motivation, learner personality, and environment factors; and
computing a motivation factors subtotal score based on said values assigned said goal setting, learner motivation, learner personality, and environment factors.

4. The method of claim 3, wherein said received indicator data relates to characterizing content and delivery factors of a job training program, said content and delivery factors comprising one or more of:
an architecture factor,
a practice factor,
a training setting factor, and
a skill type factor,
said method further comprising:
assigning values associated with each said architecture, practice, training setting and skill type factors, and
computing a content and delivery factors subtotal score based on said values assigned said architecture, practice, training setting and skill type factors.

5. The method of claim 4, wherein said architecture factor comprises: attributes integrating one or more of:
a framework attribute characterizing a size of information transferred and a learner's feedback,
one or more subject matter attributes characterizing a training program content; and
a learner knowledge attribute characterizing a learner's level of knowledge about a skill type.

6. The method of claim 5, further comprising:
characterizing said skill type as one of: an open skill type or a closed skill type; and
modifying a value assigned said skill type factor based on said subject matter attributes and one of said open or closed skill type characterization.

7. The method of claim 4, wherein said received indicator data relates to characterizing post-training factors, said post-training factors comprising one or more of:
a fitness for environment factor; and
a fitness for application factor,
said method further comprising:
assigning values associated with each said fitness for environment and fitness for application factors;
computing a post-training factors subtotal score based on said assigned said fitness for environment and fitness for application factors.

8. The method of claim 7, further comprising:
characterizing whether said training program is for one of: a motor skill or a cognitive skill, said method comprising:
modifying a value assigned said fitness for environment factor based on one of said motor skill or cognitive skill characterization.

9. The method of claim 7, further comprising:
characterizing whether said training program is for one of: a motor skill or a cognitive skill, said method comprising:
modifying a value assigned said fitness for application factor based on one of said motor skill or cognitive skill characterization.

10. The method of claim 7, wherein said computed score is based on said computed motivation factors subtotal score, said content and delivery factors subtotal score and said post-training factors subtotal score.

11. A system of forecasting skills transfer effectiveness comprising:
a memory storage device,
a hardware processor device coupled to the memory storage device and configured to perform a method to:
receive indicator data relating to a skills transfer metric;
assign a numeric value corresponding to each received indicator data;
compute a score based on said assigned numeric values;
compare said score against a predetermined threshold; and
send one or more signals to a user device for indicating a result of said comparing, said user device responsive to said result for recommending an action to admit a learner entry or deny a learner entry to a training program.

12. The system of claim 11 wherein said one or more signals indicate recommending an action to admit if said comparing results in said score being greater than said predetermined threshold.

13. The system of claim 11, wherein said received indicator data relates to characterizing trainee motivation factors, said trainee motivation factors comprising one or more of:
a goal setting factor,
a learner motivation factor,
a learner personality factor, and
an environment factor, said method further comprising:
assigning values associated with each said goal setting, learner motivation, learner personality, and environment factors;
computing a motivation factors subtotal based on said values assigned said goal setting, learner motivation, learner personality, and environment factors

14. The system of claim 13, wherein said received indicator data relates to characterizing content and delivery factors of a job training program, said content and delivery factors comprising one or more of:
an architecture factor, said architecture factor comprising attributes integrating one or more of:
a framework attribute characterizing a size of information transferred and a learner's feedback,
one or more subject matter attributes characterizing a training program content; and
a learner knowledge attribute characterizing a learner's level of knowledge about a skill type;
a practice factor,
a training setting factor, and
a skill type factor,
said hardware processor being further configured to:
assign values associated with each said architecture, practice, training setting and skill type factors, and
compute a content and delivery factors subtotal based on said values assigned said architecture, practice, training setting and skill type factors.

15. The system of claim 14, wherein said received indicator data relates to characterizing said skill type as one of: an open skill type or a closed skill type, said hardware processor device further configured to:
modify a value assigned said skill type factor based on said subject matter attributes and one of said open or closed skill type characterization.

16. The system of claim 14, wherein said received indicator data relates to characterizing post-training factors, said post-training factors comprising one or more of:
a fitness for environment factor; and
a fitness for application factor,
said hardware processor being further configured to:
assign values associated with each said fitness for environment and fitness for application factors;
compute a post-training factors subtotal based on said assigned said fitness for environment and fitness for application factors.

17. The system of claim 16, wherein said received indicator data relates to characterizing whether said training program is for one of: a motor skill or a cognitive skill, said hardware processor further configured to:
modify a value assigned said fitness for environment factor based on one of said motor skill or cognitive skill characterization.

18. The system of claim 17, wherein said received indicator data relates to characterizing whether said training program is for one of: a motor skill or a cognitive skill, said hardware processor further configured to:
modify a value assigned said fitness for application factor based on one of said motor skill or cognitive skill characterization.

19. The system of claim 17, further comprising:
computing said output score based on said computed motivation factors subtotal, said content and delivery factors subtotal and said post-training factors subtotal.

20. A computer program product for forecasting skills transfer effectiveness, the computer program product comprising a computer readable storage medium, the computer readable storage medium excluding a propagating signal, the computer readable storage medium readable by a processing circuit and storing instructions run by the processing circuit for performing a method comprising:
receiving indicator data relating to a skills transfer metric;
assigning a numeric value corresponding to each received indicator data;
computing a score based on said assigned numeric values;
comparing said score against a predetermined threshold; and
sending one or more signals to a user device for indicating a result of said comparing, said user device responsive to said result for recommending an action to admit a learner entry or deny a learner entry to a training program.
